(19) United States
(12) Patent Application Publication
(10) Pub. No.: US 2005/0098663 A1
(43) Pub. Date: May 12, 2005

(54) Fuel injector

(75) Inventor: Mitsunori Ishii, Chiyoda-ku (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI, LTD., Chiyoda-ku (JP)

(21) Appl. No.: 10/954,366

(22) Filed: Oct. 1, 2004

(30) Foreign Application Priority Data
Oct. 3, 2003 (JP) 2003-345261

(51) Int. Cl. B05B 1/30

(52) U.S. Cl. 239/584

(57) ABSTRACT

A magneto-striction element 7 is inserted and held by an element holder assembly 6. A flange 13 at the upper end of the element holder assembly 6 is positioned on a main unit case 1 of the fuel injection valve 6 as a fixed end and the lower end of the element holder assembly 6 is set as a free end which can expand and contract vertically. An inward opening specification is used that when the magneto-striction element 7 expands, the plunger 13 is pulled upward in the injection valve in the opposite direction of the combustion chamber side and from the gap between a nozzle sheet 3 arranged on the combustion chamber side and the front end of the plunger 13, fuel is injected.

### CLAIM OF PRIORITY

The present application claims priority from Japanese application serial No. 2003-345261, filed on Oct. 3, 2003, the content of which is hereby incorporated by reference into this application.

### BACKGROUND OF THE INVENTION

The present invention relates to a fuel injector of an inward opening type using a magneto-striction element suitable for an internal combustion engine.

An internal combustion engine for a car requires an advanced mixed gas forming art of injected fuel and air and a highly precise fuel injection art. To execute precise control for the fuel injection rate, a high degree of response is required for a fuel injection valve.

As a method for realizing it, for the drive system of the injection valve, in place of the conventional solenoid electromagnetic drive method, a one using a magneto-striction element has been developed. With respect to the fuel injection valve using a magneto-striction element, the outward opening type and inward opening type are known. The outward opening type fuel injection valve has a structure that the valve body (plunger) moves toward the combustion chamber.

However, in the outward opening type fuel injection valve, since the plunger is positioned in the combustion chamber, deposits are easily accumulated in the neighborhood of the front end of the fuel injection valve, and a problem arises that the spray form is changed with time by deposits or fuel cannot be made fine.

On the other hand, the inward opening type fuel injection valve, for example, as described in Japanese Laid-open Patent Publication 9-310654, has a structure that the plunger is pulled up and fuel is injected, so that a problem of accumulation of deposits is hardly imposed.

### SUMMARY OF THE INVENTION

However, as described in Japanese Laid-open Patent Publication 9-310654, in the inward opening type fuel injection valve using a magneto-striction element, the following problem is imposed. Namely, the magneto-striction element is a material that the dimensional accuracy at the time of processing is hardly obtained, so that a problem arises that dimensional variations are large. In Japanese laid-open Patent Publication 9-310654, a structure is used that a gap is provided between the slider and the plunger rod and the gap absorbs variations in the processing accuracy.

However, one end of the element is fixed to the main unit case via the element holder, so that variations in the processing dimensions of the element adversely affect straight the dimensions of the gap and a problem arises that only by the element and element holder, dimensional variations cannot be adjusted.

Further, the thermal expansion coefficient of the magneto-striction element is comparatively large, for example, about 12 ppm/° C. In an internal combustion engine for a car, the atmospheric temperature is changed extremely large such as from −30° C. to 120° C., so that for example, when the atmospheric temperature is changed by 100° C., the change in the elongation of the element reaches about 120 μm.

This elongation change is more than the request stroke (generally in the order of several tens μm) of the injection valve, so that not only precise control of the fuel injection amount cannot be executed due to the thermal expansion of the element but also according to circumstances, a problem arises that the function of the injection valve is lost.

An object of the present invention is to provide a fuel injection valve that there are very few product variations, and the problem due to the thermal expansion is solved, and the measurement accuracy and reliability are high.

(1) To accomplish the above object, the present invention provides a fuel injection valve under the inward opening specification that a magneto-striction element is used, and a plunger is pulled upward in an injection valve in the opposite direction of a combustion chamber, and fuel is injected from the gap between a nozzle sheet arranged on the combustion chamber side and the front end of the plunger, wherein an element holder for inserting and holding the magneto-striction element is installed, and the upper end of the element holder is positioned on the main unit case of the fuel injection valve as a fixed end, and the lower end of the element holder is set as a free end which is flexible in the vertical direction.

By use of such a constitution, there are very few product variations, and the problem due to the thermal expansion is solved, and the measurement accuracy and reliability can be improved.

(2) In (1) mentioned above, the magneto-striction element is preferably annular.

(3) In (1) mentioned above, the coefficient of linear expansion of the magneto-striction element is preferably equal to the coefficient of linear expansion of the element holder.

(4) In (1) mentioned above, an element receiving member arranged in contact with the upper end face of the magneto-striction element is preferably installed and between the flange of the plunger in contact with the element receiving member and the element receiving member, a gap is preferably provided.

(5) In (4) mentioned above the gap is preferably set to the minimum clearance or more obtained from the dimensional tolerance added up at the time of assembly of the components of the injection valve.

(6) In (4) mentioned above, a first elastic body arranged above the element receiving member for applying a pre-load to the magneto-striction element and a second elastic body arranged above the flange of the plunger for generating sheet force for applying a load to the plunger and pressing the front end of the plunger to the nozzle sheet are preferably installed.

(7) In (6) mentioned above, a third elastic body and a fourth elastic body arranged in the gap between the element holder and the element receiving member and respectively arranged on the inner peripheral side and outer peripheral side of the magneto-striction element are preferably installed.

(8) In (4) mentioned above, the rod of the plunger is preferably arranged at the center of the axis of the injection valve passing through the central part of the element receiving member, and the distribution of the pre-load applied to the magneto-striction element is preferably an axially symmetrical distribution having no distribution in the circumferential direction, and the distribution of the force for moving the magneto-striction element and driving the plunger rod is preferably an axially symmetrical distribution.

(9) In (4) mentioned above, the element receiving member is preferably made of a magnetic material so as to form a part of the magnetic path.

(10) Further, to accomplish the above object, the present invention provides a fuel injection valve under the inward opening specification that a magneto-striction element is used, and a plunger is pulled upward in an injection valve in the opposite direction of a combustion chamber, and fuel is injected from the gap between a nozzle sheet arranged on the combustion chamber side and the front end of the plunger, wherein an element holder for inserting and holding the magneto-striction element is installed, and the upper end of the element holder is positioned on the main unit case of the fuel injection valve as a fixed end, and the lower end of the element holder is set as a free end which is flexible in the vertical direction, and the magneto-striction element is annular.

By use of such a constitution, there are very few product variations, and the problem due to the thermal expansion is solved, and the measurement accuracy and reliability can be improved.

(11) Further, to accomplish the above object, the present invention provides a fuel injection valve under the inward opening specification that a magneto-striction element is used, and a plunger is pulled upward in an injection valve in the opposite direction of a combustion chamber, and fuel is injected from the gap between a nozzle sheet arranged on the combustion chamber side and the front end of the plunger, wherein an element holder for inserting and holding the magneto-striction element is installed, and the upper end of the element holder is positioned on the main unit case of the fuel injection valve as a fixed end, and the lower end of the element holder is set as a free end which is flexible in the vertical direction, and the magneto-striction element is annular, and the coefficient of linear expansion of the magneto-striction element is equal to the coefficient of linear expansion of the element holder.

By use of such a constitution, there are very few product variations, and the problem due to the thermal expansion is solved, and the measurement accuracy and reliability can be improved.

(12) Further, to accomplish the above object, the present invention provides a fuel injection valve under the inward opening specification that a magneto-striction element is used, and a plunger is pulled upward in an injection valve in the opposite direction of a combustion chamber, and fuel is injected from the gap between a nozzle sheet arranged on the combustion chamber side and the front end of the plunger, wherein an element holder for inserting and holding the magneto-striction element and an element receiving member arranged in contact with the upper end face of the magneto-striction element are installed, and the upper end of the element holder is positioned on the main unit case of the fuel injection valve as a fixed end, and the lower end of the element holder is set as a free end which is flexible in the vertical direction, and the magneto-striction element is annular, and between the flange of the plunger in contact with the element receiving member and the element receiving member, a gap is provided.

By use of such a constitution, there are very few product variations, and the problem due to the thermal expansion is solved, and the measurement accuracy and reliability can be improved.

(13) Further, to accomplish the above object, the present invention provides a fuel injection valve under the inward opening specification that a magneto-striction element is used, and a plunger is pulled upward in an injection valve in the opposite direction of a combustion chamber, and fuel is injected from the gap between a nozzle sheet arranged on the combustion chamber side and the front end of the plunger, wherein a plunger drive mechanism by the magneto-striction element which is extended by a magnetic field generated by supplying power to a coil and when the magneto-striction element is extended more than a certain length, starts to pull the plunger upward is provided.

By use of such a constitution, there are very few product variations, and the problem due to the thermal expansion is solved, and the measurement accuracy and reliability can be improved.

The present invention provides a fuel injection valve that there are very few product variations, and the problem due to the thermal expansion is solved, and the measurement accuracy and reliability are high.

### BRIEF DESCRIPTION OF THE DRAWINGS

FIG. 1 is a cross sectional view showing the whole constitution of the fuel injection valve of an embodiment of the present invention;

FIG. 2 is an assembly drawing of the fuel injection valve of an embodiment of the present invention;

FIG. 3 is an operation illustration for the fuel injection valve of an embodiment of the present invention; and

FIG. 4 is a cross sectional view showing the whole constitution of the fuel injection valve of another embodiment of the present invention.

### DESCRIPTION OF THE PREFERRED EMBODIMENTS

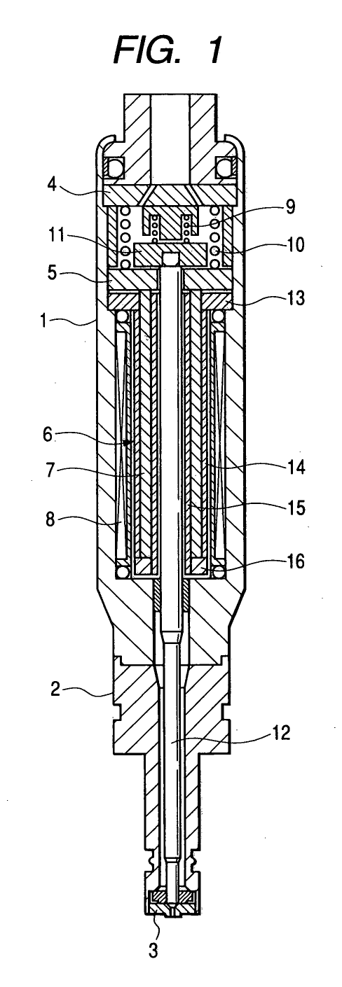

The constitution of the fuel injection valve of an embodiment of the present invention will be explained below with reference to FIGS. 1 to 3.

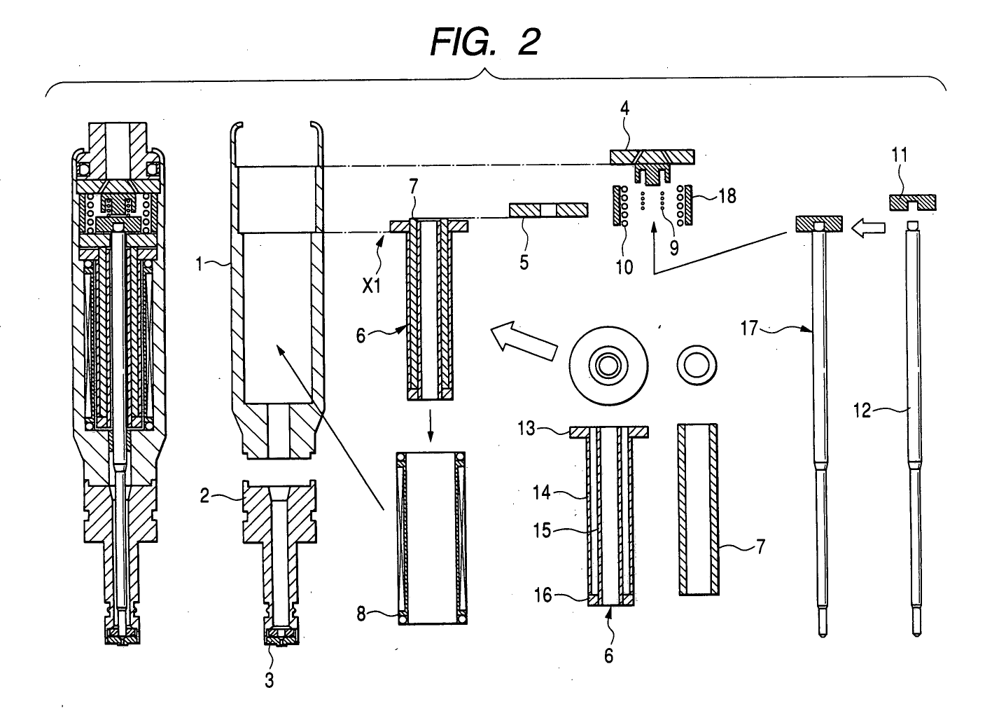

Firstly, by referring to FIGS. 1 and 2, the whole constitution of the fuel injection valve of this embodiment will be explained.

FIG. 1 is a cross sectional view showing the whole constitution of the fuel injection valve of an embodiment of the present invention. FIG. 2 is an assembly drawing of the fuel injection valve of an embodiment of the present invention. In FIGS. 1 and 2, the same numerals indicate the same parts.

Hereinafter, mainly, by referring to FIG. 2, the constitution of the fuel injection valve of this embodiment will be explained. A nozzle sheet 3 is fit into the front end of a nozzle body 2. In the nozzle sheet 3, a nozzle is formed and the shape thereof is the same as the conventional one. The shape of the front end of a plunger rod 12 in contact with the nozzle sheet 3 is the same as the conventional one.

The plunger rod 12 is an integral comparatively long rod interconnecting from the nozzle sheet to the upper part of the element drive portion. On the upper part of the plunger rod 12, a flange 11 is installed integrally with the rod 12 and constitutes a plunger assembly 18. At the upper end of the plunger rod 12, an elastic body such as a plunger sheet spring 9 held by a stopper 4 is arranged. The spring 9, via the plunger rod 12, can always act an appropriate load to the nozzle sheet 3 completely independently of the element portion. The load of the sheet portion is sheet force necessary to prevent the nozzle sheet portion from leakage of fuel.

A magneto-striction element 7 is cylindrical. The cylindrical magneto-striction element 7 is inserted into an element holder assembly 6 installed in the cylindrical inner groove. The element holder assembly 6 is composed of a holder outer cylinder 14, a holder inner cylinder 15, a holder flange 13, and a holder bottom plate 16, which are integrated with each other. The holder outer cylinder 14 and the holder inner cylinder 15 are arranged concentrically with each other and in the inner groove formed between the two, the magneto-striction element 7 is inserted.

The holder flange 13 projected in the horizontal direction on the upper part of the element holder assembly 6 is fit, positioned, and fixed to the main unit case 1 of the injection valve. Here, the position X1 of the fixed holder flange 13 is a fixed end.

The holder inner cylinder 15 is not always installed, and it is a protection tube for protecting the magneto-striction element 7 which is made of a comparatively fragile material, and it can play a roll of preventing the magneto-striction element 7 from making direct contact with the plunger rod 12 and subject to wear. Further, the holder inner cylinder 15 may be used as a guide member when the plunger rod 12 slides vertically.

The element holder assembly 6 and the main unit case 1 are fixed only at the portion of the holder flange 13 and the lower end of the element holder assembly 6 is formed as a free end which is provided with a gap and can be freely deformed vertically. Further, the holder outer cylinder 14 and the holder inner cylinder 15 are made of a non-magnetic material and the bottom plate 16 of the element holder is made of a magnetic material. Further, the holder outer cylinder 14 is made of a material having the same thermal expansion coefficient as the thermal expansion coefficient of the magneto-striction element 7. For example, the element receiving member 5 and the bottom plate 16 use SUS420J2 which is a magnetic material and the holder flange 13, the holder outer cylinder 14, and the holder inner cylinder 15 use K-M35FL which is a non-magnetic material.

Further, when the coefficient of linear expansion of the magneto-striction element 7 is 12 ppm, if as a material of the holder outer cylinder 14, K-M35FL is used, the coefficient of linear expansion thereof is also 12 ppm and can be made equal to the coefficient of linear expansion of the magneto-striction element 7.

Further, when the aforementioned materials are used for the holder outer cylinder 14, the flange 13, and the bottom plate 16 of the element holder, an injection valve having the elongation of the magneto-striction element 7 and the tensile strength withstandable for the extension force generated by the magneto-striction element and the pre-load can be obtained.

Further, the sectional area of the outer cylinder 14 is a sectional area withstandable for the elongation force generated by the magneto-striction element 7.

On the upper end face of the magneto-striction element 7 inserted into the element holder assembly 6, the element receiving member 5 is arranged. On the top of the element receiving member 5, an elastic body such as an element pre-load spring 10 guided by the guide 18 is arranged. By the elastic body such as the spring 10, to the magneto-striction element 7, a fixed pre-load is given always via the element receiving member 5.

Further, between the upper part of the element receiving member 5 and the plunger flange 11 installed on the upper part of the plunger rod 12, an appropriate gap is provided in the vertical direction (the stroke direction). By this gap, the nozzle sheet force and the element pre-load can be set independently. Further, the gap length, in consideration of processing variations (tolerance) of each component, is predetermined. Namely, from the final tolerance of each component, the gap length may be obtained as more than 0.

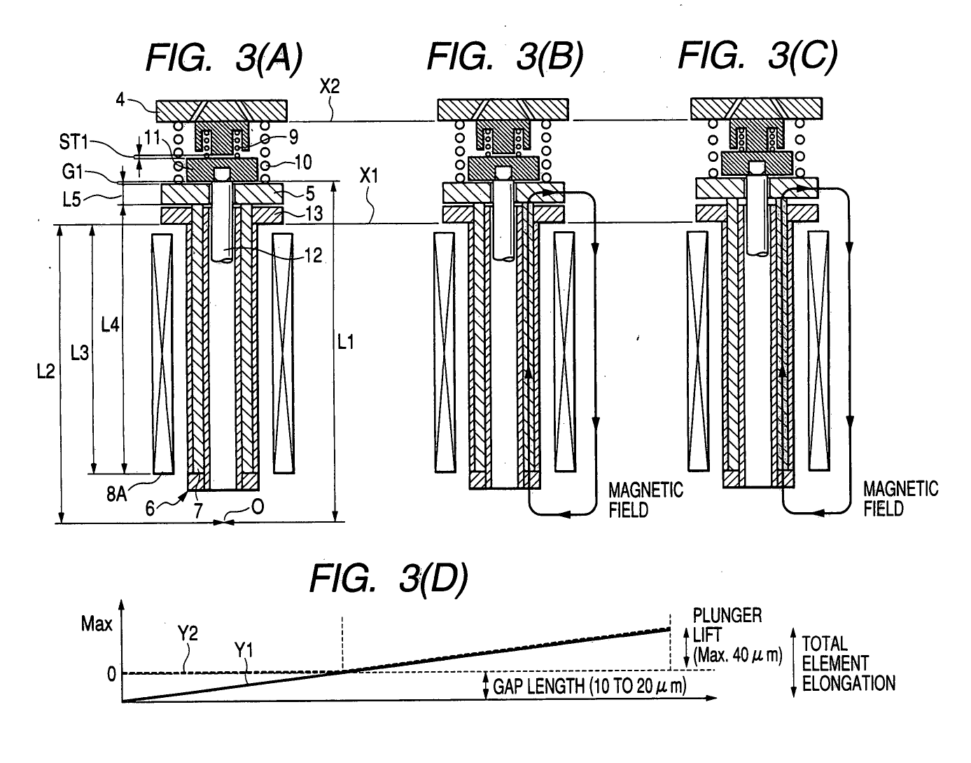

Next, by referring to FIG. 3(A), the gap length will be explained. The gap length provided between the upper part of the element receiving member 5 and the plunger flange 11 is assumed as G1. In FIG. 3(A), the origin O, for example, is set to the position where the front end of the rod 12 shown in FIG. 1 makes contact with the nozzle sheet 3. The length from the origin O to the bottom of the plunger flange 11 is assumed as L1. And, the length L1 is assumed to have a tolerance of ΔL1.

Further, the length from the origin O to the bottom of the holder flange 13 is assumed as L2. And, the length L2 is assumed to have a tolerance of ΔL2. Furthermore, the length of the holder outer cylinder 14 is assumed as L3. And, the length L3 is assumed to have a tolerance of ΔL3. Furthermore, the length of the magneto-striction element 7 is assumed as L4. And, the length L4 is assumed to have a tolerance of ΔL4. Furthermore, the thickness of the element receiving member 5 is assumed as L5. And, the thickness L5 is assumed to have a tolerance of ΔL5. At this time, the gap length G1 can be expressed by the following formula (1).
G1=L1−(L2−L3+L4+L5) (1)

When the tolerance Δ is added to the formula (1), it can be replaced with the following formula (2).
G1=(L1+ΔL1)−((L2+ΔL2)−(L3+ΔL3)+(L4+ΔL4)+(L5+ΔL5)) (2)

That the gap length G1 is set to more than 0 is that the following formula (3) is satisfied.
G1−((L1+ΔL1)−(L2+ΔL2)−(L3+ΔL3)+(L4+ΔL4)+(L5+ΔL5))>0 (3)

Namely, in this embodiment, the gap G1 provided between the magneto-striction element 7 and the plunger rod 12, that is, the gap length G1 provided between the upper part of the element receiving member 5 and the plunger flange 11 is set to the minimum clearance or more obtained from the dimensional tolerance added at the time of assembly of each component of the injection valve.

Furthermore, also between the top of the plunger flange 11 integrated with the plunger rod 12 and the stopper (plunger receiver) 4, a gap (stroke amount) is provided and the gap is an effective stroke of the plunger. In correspondence to the stroke of the plunger, the nozzle starts to open the valve. However, finally, a constitution that by the stopper 4 fixed to the main unit case 1, the maximum lift is controlled is used. Further, in the gap portion and the stoke portion, a fine adjustment shim may be installed. Further, as a stroke adjustment mechanism of the plunger 13, a constitution similar to the conventional one may be used.

Further, on the further outer peripheral side of the element holder assembly 6, a coil incorporated in a coil bobbin assembly 8 is arranged.

Further, a fuel path is arranged by providing a hole or a groove in a part of the components. Further, in the plunger rod 12, a clearance may be formed between the rod 12 and the element holder assembly 6 so as to be used as a fuel path and the rod 12 may be formed in a cylindrical shape so as to provide a fuel path at the central part.

Next, by referring to FIG. 3, the operation of the fuel injection valve in this embodiment will be explained.

FIG. 3 is an illustration for the operation of the fuel injection valve of an embodiment of the present invention. Further, the same numerals as those shown in FIGS. 1 and 2 indicate the same parts.

FIG. 8(A) shows a state that no power is supplied to a coil 8A. At this time, between the element receiving member 5 and the plunger flange 11, the adjustment gap G1 is formed. Further, at this time, between the plunger flange 11 and the stopper 4, the gap (stroke length) L1 for the plunger lift is formed.

When power is supplied to the coil 8A, as shown in FIG. 8(B), a magnetic field is generated around it. By the generated magnetic field, the magneto-striction element 7 starts to extend and in correspondence to the extension of the element 7, the element receiving member 5 moves upward.

When the magnetic field becomes stronger and the element 7 is extended as shown in FIG. 8(C), the gap G1 is reduced to 0, and the element receiving member 5 and the flange 11 of the plunger rod 12 are adhered closely to each other, and the plunger rod 12 is pushed up. Finally, the pushed-up plunger rod 12 makes contact with the stopper 4 and stops.

The gap L1 between the plunger rod 12 and the stopper 4 is an effective lift of the injection valve. Further, the gap G1 between the element receiving member 5 and the flange 11 of the plunger rod 12 is a final fine adjustment portion to adjust in correspondence with fine dimensional variations in each component of the injection valve within the processing tolerance and slight changes in the use environmental conditions, thus the dimensional accuracy of the injection valve can be improved more. Further, here, comparatively large dimensional variations of the element itself are absorbed by selective fitting into the element holder.

Namely, for example, assuming that the length of the magneto-striction element 7 is longer than the specified dimension by 20 μm, a holder outer cylinder 14 longer than the specified dimension by about 20 μm is selected and the two are assembled as parts of the same fuel injection valve. This embodiment uses such a two-step dimension adjustment mechanism.

In FIG. 8(D), a solid line Y1 indicates a lift amount of the element receiving member 5 and a dashed line Y2 indicates a lift amount of the plunger 12. The sum of the length of the gap G1 and the plunger lift L1 as shown in the drawing is the overall elongation of the magneto-striction element 7. The length of the gap G1 is, for example, 10 to 20 μm and the plunger lift L1 is, for example, 40 μm. When the gap G1 is provided, if power is supplied to the coil 8A, the magneto-striction element 7 is extended. However, firstly, the magneto-striction element 7 is extended, thus only the element receiving member 5 moves upward and is lifted up. When the magneto-striction element 7 is extended up to the length of the gap G1, at that time, the plunger 12 starts lift up.

Further, when the temperature atmosphere in use is changed and the length of the element is changed by the thermal expansion, the element holder assembly 6 having the same coefficient of linear expansion as that of the element perfectly follows (in proportion) the extension of the magneto-striction element 7 and expands and contracts at the free end, so that at the position X1 of the fixed end of the element holder assembly 6 and the main unit case 1, the assembly 6 is apparently equivalent to a state free of thermal expansion.

Therefore, the dimension between the position X1 of the fixed end of the element holder assembly 6 and the position of the upper end face of the magneto-striction element 7 is always kept fixed relatively, so that highly accurate dimension setting is enabled and manufacture variations in products can be suppressed. Furthermore, super accurate control of the fuel injection rate can be executed.

Further, dimensional changing due to the thermal expansion is a phenomenon similarly presented not only in the magneto-striction element but also in the plunger rod and main unit case. However, the plunger rod and main unit case are made of metallic materials having the same thermal expansion coefficient, so that the dimensional changing due to the thermal expansion can be automatically cancelled.

Namely, a two-step independent cancel mechanism is used that by appropriate selection of an element holder material, the difference in thermal expansion between the element and the element holder portion is cancelled and furthermore the difference in thermal expansion between the main unit case and the plunger rod is cancelled. Further, if the thermal expansion coefficient of the element does not coincide perfectly with that of the element holder, for the components of the plunger rod, main unit case, and nozzle body affecting the gap length, materials having various different and appropriate thermal expansion coefficients are combined, thus the gap length to be set finally can be kept at a certain fixed value.

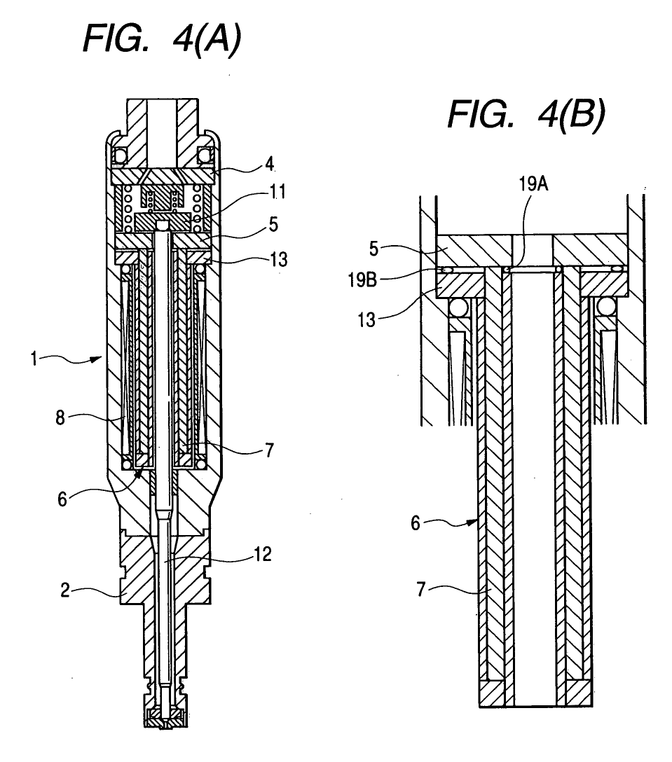

Next, by referring to FIG. 4, the constitution of the fuel injection valve of another embodiment of the present invention will be explained.

FIG. 4 is a cross sectional view showing the whole constitution of the fuel injection valve of another embodiment of the present invention. FIG. 4(A) is an entire view thereof and FIG. 4(B) is a partially enlarged view of FIG. 4(A). The same numerals as those shown in FIGS. 1 and 2 indicate the same parts.

The basic constitution of this embodiment is the same as that shown in FIGS. 1 to 3. In this embodiment, in addition to the constitution shown in FIG. 1, in the gap portion between the holder flange 13 of the element holder assembly 6 and the element receiving member 5, elastic bodies 19A and 19B such as O-rings or rubber are mounted on the inner peripheral side and outer peripheral side so as to surround the magneto-striction element.

In the gap portion, the gap length is changed by the expansion and contraction of the element, so that to fix the seal member, a fixed groove such as an O-ring groove may be formed on the holder side or the element receiving member side. Further, the top or bottom of the seal member may be adhered.

The magneto-striction element 7 is made of a comparatively fragile material, and when it is repeatedly expanded and contracted at a large load, the corners of the element end face are easily chipped, and chipped small fragments are dissolved into fuel, and the injection valve nozzle may be clogged or the movable part may be worn away. Therefore, the flexible elastic bodies 19A and 19B are respectively mounted on the outer peripheral side and inner peripheral side of the element, thus even if a part of the element is chipped, fragments thereof can be prevented from flowing into fuel.

Further, the injection valve is filled with high-pressure fuel. However, the elastic bodies 19A and 19B are used to prevent small chipped fragments of the element from flowing to the outside and do not aim at sealing high-pressure fuel, so that minute fuel leakage from the gap does not matter.

Further, the mounting position of the seal member 19B installed on the outer peripheral side of the element is set on the outer peripheral side (large diameter) of the element receiving member 5 inasmuch as is possible, thus the falling and bending of the columnar element receiving member 5 with a comparatively large diameter can be buffered. Further, the outer seal member 19B is widened, thus the falling and bending of the element receiving member can be further eliminated.

Further, in the above explanation, the magneto-striction element 7 uses a cylindrical element, though for example, two semi-cylindrical elements may be combined and arranged in a cylindrical shape. Further, thin columnar magneto-striction elements may be evenly arranged in a shape of torus around the plunger rod 12. Namely, as a magneto-striction element, an annular element in which extension force evenly acts on the flange 11 of the plunger rod 12 may be used.

As explained above, according to this embodiment, the dimensions of the plunger portion and element portion requiring high accuracy can be set independently, and the portions are structured free of mutual interference, thus the reliability is high, and there are few manufacture variations, and high dimensional accuracy can be realized, so that highly precise fuel injection amount control can be executed. Further, a constitution that a rapid response magneto-striction element directly drives the plunger is used, so that compared with the conventional solenoid type, the valve opening delay and closing delay are greatly shortened and very rapid response and highly precise fuel injection amount control can be executed.

The meaning of the reference signs are as follows:

1 . . . Main unit case, 2—-Nozzle body, 3 . . . Nozzle sheet, 4 . . . Stopper, 5 . . . Element receiving member, 6 . . . Element holder assembly, 7 . . . Magneto-striction element, 8 . . . Coil bobbin assembly, 9 . . . Plunger sheet elastic body, 10 E . . . element pre-load elastic body, 11 . . . Plunger flange, 12 . . . Plunger rod, 13 . . . Holder flange, 14 . . . Holder outer cylinder, 15 . . . Holder inner cylinder, 16 . . . Holder bottom plate, 17 . . . Plunger assembly, 18 . . . Guide.

1. A fuel injection valve of an inward opening type mounted on a combustion chamber comprising:
a magneto-striction element;
a plunger;
a nozzle sheet arranged on combustion chamber side, said plunger being pulled upward by said magneto-striction element in an injection valve in an opposite direction of the combustion chamber, and fuel being injected from a gap between said nozzle sheet and a front end of said plunger; and
an element holder for inserting and holding said magneto-striction element; and
wherein an upper end of said element holder is positioned on a main unit case of said fuel injection valve as a fixed end and a lower end of said element holder is set as a free end flexible in a vertical direction.

2. A fuel injection valve according to claim 1, wherein said magneto-striction element is annular.

3. A fuel injection valve according to claim 1, wherein a coefficient of linear expansion of said magneto-striction element is equal to a coefficient of linear expansion of said element holder.

4. A fuel injection valve according to claim 1, further comprising an element receiving member arranged in contact with an upper end face of said magneto-striction element, wherein a gap is provided between a flange of said plunger in contact with said element receiving member and said element receiving member,

5. A fuel injection valve according to claim 4, wherein said gap is set to a minimum clearance or more obtained from a dimensional tolerance added up at the time of assembly of components of said injection valve.

6. A fuel injection valve according to claim 4, further comprising a first elastic body arranged above said element receiving member for applying a pre-load to said magneto-striction element, and a second elastic body arranged above said flange of said plunger for generating sheet force for applying a load to said plunger and pressing a front end of said plunger to said nozzle sheet.

7. A fuel injection valve according to claim 6, further comprising a third elastic body and a fourth elastic body arranged in a gap between said element holder and said element receiving member and respectively arranged on an inner peripheral side and an outer peripheral side of said magneto-striction element.

8. A fuel injection valve according to claim 4, further comprising a rod of said plunger arranged at a center of an axis of said injection valve passing through a central part of said element receiving member, wherein a distribution of a pre-load applied to said magneto-striction element is an axially symmetrical distribution having no distribution in a circumferential direction and a distribution of force for moving said magneto-striction element and driving said plunger rod is an axially symmetrical distribution.

9. A fuel injection valve according to claim 4, wherein said element receiving member is made of a magnetic material so as to form a part of a magnetic path.

10. A fuel injection valve of an inward opening type mounted on a combustion chamber comprising:
a magneto-striction element;
a plunger;
a nozzle sheet arranged on combustion chamber side, said plunger being pulled upward by said magneto-striction element in an injection valve in an opposite direction of the combustion chamber, and fuel being injected from a gap between said nozzle sheet and a front end of said plunger; and
an element holder for inserting and holding said magneto-striction element; wherein
an upper end of said element holder is positioned on a main unit case of said fuel injection valve as a fixed end and a lower end of said element holder is set as a free end flexible in a vertical direction, and said magneto-striction element is annular.

11. A fuel injection valve of an inward opening type mounted on a combustion chamber comprising:
a magneto-striction element;
a plunger;
a nozzle sheet arranged on combustion chamber side, said plunger being pulled upward by said magneto-striction element in an injection valve in an opposite direction of the combustion chamber, and fuel being injected from a gap between said nozzle sheet and a front end of said plunger; and
an element holder for inserting and holding said magneto-striction element; wherein
an upper end of said element holder is positioned on a main unit case of said fuel injection valve as a fixed end and a lower end of said element holder is set as a free end flexible in a vertical direction, said magneto-striction element is annular, and a coefficient of linear expansion of said magneto-striction element is equal to a coefficient of linear expansion of said element holder.

12. A fuel injection valve of an inward opening type mounted on a combustion chamber comprising:
a magneto-striction element;
a plunger;
a nozzle sheet arranged on combustion chamber side, said plunger being pulled upward by said magneto-striction element in an injection valve in an opposite direction of the combustion chamber, and fuel being injected from a gap between said nozzle sheet and a front end of said plunger;
an element holder for inserting and holding said magneto-striction element; and
an element receiving member arranged in contact with an upper end face of said magneto-striction element, wherein
an upper end of said element holder is positioned on a main unit case of said fuel injection valve as a fixed end and a lower end of said element holder is set as a free end flexible in a vertical direction, said magneto-striction element is annular, and a gap is provided between a flange of said plunger in contact with said element receiving member and said element receiving member.

13. A fuel injection valve of an inward opening type mounted on a combustion chamber comprising:
a magneto-striction element;
a plunger;
a nozzle sheet arranged on combustion chamber side, said plunger being pulled upward by said magneto-striction element in an injection valve in an opposite direction of the combustion chamber, and fuel being injected from a gap between said nozzle sheet and a front end of said plunger; and
a plunger drive mechanism by said magneto-striction element which is extended by a magnetic field generated by supplying power to a coil and when said magneto-striction element is extended more than a certain length, starts to pull said plunger upward.
